(19) United States
(12) Patent Application Publication
(10) Pub. No.: US 2006/0136438 A1
(43) Pub. Date: Jun. 22, 2006

(54) Process server array for processing documents and document components and a method related thereto

(76) Inventor: Peter S. McChrystal, Indialantic, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/313,227

(22) Filed: Dec. 20, 2005

Related U.S. Application Data
(60) Provisional application No. 60/637,988, filed on Dec. 20, 2004.

(51) Int. Cl. G06F 17/00

(52) U.S. Cl. 707/100

(57) ABSTRACT

A process server array comprising a plurality of process servers for a document management system. A user request to operate on documents or document components stored in a document repository of the document management system is provided to an available process server of the plurality of process servers. The available processor further decomposes files into constituent components to permit browsing, searching and retrieving of the components across files.

This application claims the benefit of U.S. Provisional Patent Application No. 60/637,988 filed on Dec. 20, 2004.

### FIELD OF THE INVENTION

This invention relates generally to documents and their components stored in a document repository or library for use by a plurality of users, and more specifically to a process server array for managing and manipulating documents and document components.

### BACKGROUND OF THE INVENTION

In today's business environment computer users create many different document types, and during any workday each user creates many such documents. Document types, which are typically stored in the form of files, include text files, presentation files, database files and spreadsheets files. These document types can be further classified into two categories, structured and unstructured. The structured category includes information that is created and maintained in a rigorously defined arrangement, such as a database. Unstructured includes most of the remaining document types, e.g. text files, presentation files, spreadsheets, etc. The great majority of digital information is in the unstructured form.

In a business enterprise, the documents can be stored locally on an individual user's computer storage media (such as a hard disc drive) or stored on one or more file servers accessible to all users. The documents stored on the file servers are revised by the author or another contributor, and others with access to the stored document files can generate derivative documents (files) using components paragraphs, pages, charts, slides, etc.) copied from the original (source) document file. For example, a controller consults the spreadsheet prepared by an accounting manager to create a financial report for senior management. An engineer relies on a component price set forth in a database document prepared by a buyer, for use in preparing a customer proposal. It is a document's content components (e.g., individual facts, ideas, charts, pictures, conclusions, etc., within the document), and not the document as a whole, that are continually reused in new combinations to form derivative documents for other business purposes. Although only the document components i.e., unstructured business information, are needed and used by others, the components are stored and accessed as document files.

To generate the derivative document according to the prior art, the stored source file is copied from the server to the user's computer, desired components are selected from the document and copied into the derivative document created by the user. Typically, the user copies the entire original document and extracts the desired components therefrom, unless the user has advance knowledge of the original document contents, in which case the user can locate and copy only those components. Known techniques for document management and use operate at the file level, limiting the user's capability to manage information below the file level.

Although widespread availability and use of these documents' content is crucial to the organization’ mission, it is recognized that modification of a source document will not be captured by a derivative document prepared prior to the modification. Thus, before a user can finalize his document, he must check the source document one last time to ensure that it has not been modified.

### BRIEF SUMMARY OF THE INVENTION

According to one embodiment, the present invention comprises a process server array for a document management system. The process server array comprises a plurality of processors and a queuing component for receiving document processing requests for managing a document stored in a document repository of the document management system and assigning each request to an available one of the plurality of processors, wherein each request comprises an instruction for processing components of the document by an available one of the plurality of processors.

According to another embodiment, the invention comprises a method for managing information within a source file. The method comprises importing the source file to a file repository, initiating a request to decompose the source file into one or more components, providing the request to a process server array comprising a plurality of process servers, assigning the request to an available process server from the plurality of process servers, by operation of the available process server decomposing the source file into the one or more components and storing the one or more components to the file repository.

### BRIEF DESCRIPTION OF THE DRAWINGS

The present invention can be more easily understood and the further advantages and uses thereof more readily apparent, when considered in view of the following detailed description when read in conjunction with the following figures, wherein:

FIG. 1 schematically illustrates components of a document management system operative with the process server array of the present invention.

FIG. 2 is a flowchart illustrating steps for operating the document management system of FIG. 1.

FIG. 3 illustrates a process server array of the present invention. in block diagram form.

FIG. 4 is a flowchart illustrating steps for operating the process server array of FIG. 3.

In accordance with common practice, the various detailed features are not drawn to scale, but are drawn to emphasize specific features relevant to the invention. Like reference characters denote like elements throughout the figures and text.

### DETAILED DESCRIPTION OF THE INVENTION

Before describing in detail an embodiment of a process server array for managing and manipulating documents below the file level in accordance with the present invention, it should be observed that the present invention resides primarily in a novel combination of hardware and software elements. Accordingly, so as not to obscure the disclosure with details that will be readily apparent to those skilled in the art having the benefit of the description herein. In the description that follows, certain hardware and software elements have been described with lesser detail, while the drawings and specification describe in greater detail other elements and steps pertinent to understanding the invention. The following embodiments are not intended to define limits as to the structure or use of the invention, but only to provide exemplary constructions. The embodiments are permissive rather than mandatory and illustrative rather than exhaustive.

The processes associated with importing and decomposing digital documents into document components, managing the documents and components, creating new documents from components, forming relationships between these components, and distributing and sharing these components and documents within the context of a digital library repository comprises a document management system that is described and claimed in a copending commonly-owned application entitled Method and Apparatus for Managing and Manipulating Digital Files at the File Component Level, filed on Apr. 7, 2005 and assigned application Ser. No. 11/101,194. This application is hereby incorporated by reference. The document management system of the copending application can accept common digital documents, decompose these documents into components, and then use the components to create new documents or relationships between components, whereas known prior art document management systems manage each document as a single atomic entity.

The document management system permits management of unstructured information within documents and files at a document or file component level, i.e., objects within the document or the file, such as phrases within documents or individual slides or charts within presentations. The user can browse, search, retrieve and repurpose information at the file component level, including directly accessing and retrieving slides, pages, paragraphs, charts, etc. The user creates new documents (derivative documents) including file components that are selected and retrieved from the documents stored in the digital library (source documents).

The document management system also permits a document creator or document administrator to control specific file components. For example, users may be prohibited from editing file components, but may be permitted to copy those components to create the derivative document.

The document management system also includes the capability to form relationships between predetermined file components. That is, certain file components can be linked into a group for a specified purpose. The selected components are assigned to a virtual information unit such that when a user selects one component from the virtual information unit, all linked components are included within the selected group, thereby requiring the user to select the entire group. This feature ensures the integrity of the information presented in the derivative document. For example, a finance document comprises a plurality of file components, including for example charts, text, tabular entries and a mandatory document disclaimer. By linking the file components with the mandatory disclaimer, when a user extracts one or more file components, she also receives the mandatory disclaimer linked to those components. In this way the systems ensures that the disclaimer appears with the extracted components when presented in the derivative document.

The document management system enables a user to construct new files (i.e., derivative documents) from existing file components by selecting desired file components from existing documents. The file components can also be browsed and/or searched prior to selecting components for retrieval. By way of example, and not limitation, a search process returns the following exemplary file components: portable document format (.pdf) pages in a file, individual slides of a PowerPoint® presentation, charts included within a document file and a Microsoft Word® page or paragraph.

To permit the construction of new documents from the file components or subfiles, the document management system stores decomposes the document files in the repository into file components. Components can include individual slides from a multi-slide presentation document, pages or paragraphs from a text document and objects (e.g., charts, tables) and files embedded in a document. Preferably, the digital library system (also referred to as a librarian) stores a plurality of information elements (metadata or tags) about each information file and its components to provide the capabilities offered by the present invention. The file components can be searched and managed, and selected file components can be used to assemble a new document.

The process server array of the present invention decomposes the document files into components or subparts when the files enter the document repository. The array also operates to combine the components into new documents (referred to as a document assembly process) as commanded by a user or in response to pre-established system rules.

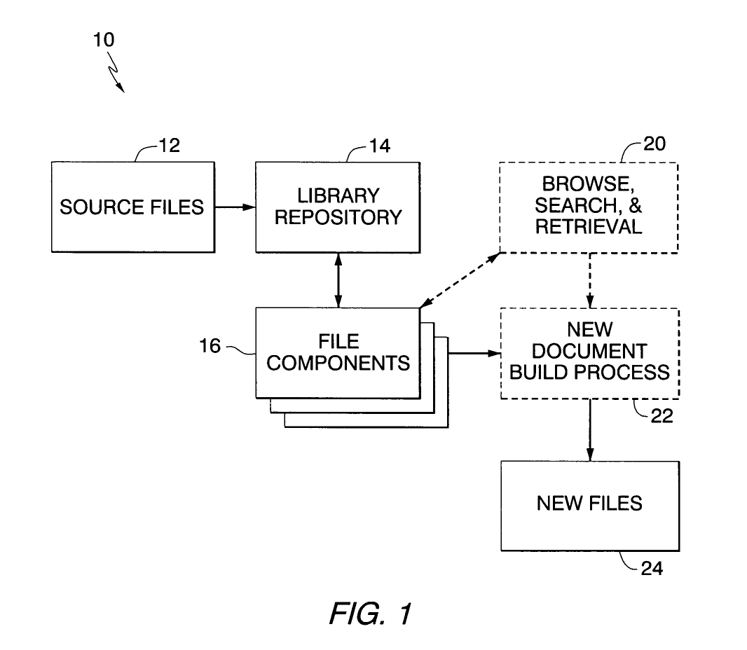

FIG. 1 schematically illustrates a document management system 10 operative with the processor server array of the present invention. When source files 12 are imported into a library repository 14, each source file is decomposed into file components 16. The process server array tracks the file components 16 stored in the library repository 14 as individual objects, thereby allowing viewing and searching at the object level. Tracking the individual objects also permits establishing relationships or links between objects such that when a user selects an object all linked objects are also provided. As indicated by a block 20, a user can browse and search the file components across all files in the repository 14 and retrieve selected file components. As indicated by a block 22, a new or derivative file or document 24 is built from the selected file components. Typically, the new or derivative file or document 24 comprises file components retrieved from files stored in the library repository 14 and new document elements created by the user.

The document management system 10 can manage any document format, including, but not limited to, documents prepared using Microsoft's Office® suite of applications (e.g., Excel®, Word®, PowerPoint®, and Access®), Adobe® portable document format, Adobe® Framemaker, Adobe® InDesign, Quark Express, Microsoft Project® and Microsoft Visio® or other known rich-media document formats.

According to a preferred embodiment, the document management software engine is embodied as a plug-in to a computer operating system and/or to known applications running under that operating system. In another embodiment the engine operates as a standalone application running on an individual user's computer or on a collectively accessed server in either a client-server or web-based configuration.

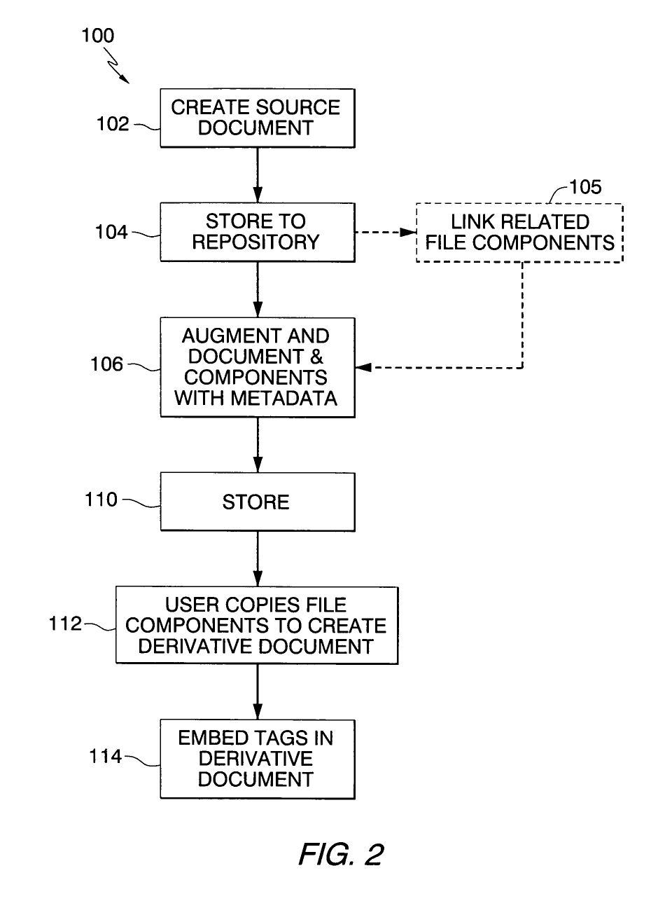

FIG. 2 illustrates a flow chart 100 depicting the steps associated with a document management process. In one embodiment, the FIG. 2 method is implemented in a microprocessor and associated memory elements within a client computer and/or within a central repository. In such an embodiment the FIG. 2 steps represent a program stored in the memory element and operable in the microprocessor. When implemented in a microprocessor, program code configures the microprocessor to create logical and arithmetic operations to process the flow chart steps. The invention may also be embodied in the form of computer program code written in any of the known computer languages containing instructions embodied in tangible media such as floppy diskettes, CD-ROM's, hard drives, DVD's, removable media or any other computer-readable storage medium. When the program code is loaded into and executed by a general purpose or a special purpose computer, the computer becomes an apparatus for practicing the invention. The invention can also be embodied in the form of a computer program code, for example, whether stored in a storage medium loaded into and/or executed by a computer or transmitted over a transmission medium, such as over electrical wiring or cabling, through fiber optics, or via electromagnetic radiation, wherein when the computer program code is loaded into and executed by a computer, the computer becomes an apparatus for practicing the invention.

The FIG. 2 flow chart 100 begins at a step 102 where a source document (file or source file) is created and imported to the library repository 14 at a step 104. When the source file 12 and its components 16 are imported into the repository 14, the file 12 and the file components 16 (objects) are parsed (decomposed) and encrypted (in one embodiment). Also, characters/code strings (referred to as tags or metadata) are created to represent various attributes of the document/file and its components, including: properties, text, page objects, layout and background. See a step 106. This list is merely exemplary and can be augmented with additional file and component attributes as desired. Copies of the metadata are embedded within or stored separate from the document and associated with the source file 12 and the file's components 16, as well as in the repository 14, as indicated by a step 110. In one embodiment the metadata is encrypted.

As depicted at a step 112, a user selects source document/components 12/16 from the library repository 14 to a local computer storage device to create the derivative document/components 24 based thereon. As indicated at a step 114, the tags associated with the source file/components 12 are embedded in or stored locally and associated with the derivative file/components 24.

Alternatively, at a step 105, related components are linked into a virtual file or information unit. Later at the step 112, when the user selects one or more file components, all components linked with a selected file component are also automatically selected.

Although the document management system 10 has been described with respect to derivative documents and derivative document components stored locally, i.e., on a user's local computer for example, the present invention is not so limited. The derivative documents and derivative document components may be stored on a shared network drive or another data storage device accessible by all potential users.

Additionally, once the derivative document is created from file components retrieved from the repository library, in the event one of the file components stored in the library is modified, for example by the file author, the modification is propagated to the file components within the derivative documents. This invention is described and claimed in the commonly owned patent application assigned application Ser. No. 11/061,093, filed on Feb. 19, 2005, and entitled “Method and Apparatus for Automatic Update and Notification of Documents and Document Components Stored in a Document Repository”.

Further details of the document management system using a PowerPoint® file as an example, is described. When a PowerPoint® file is imported into the library repository 14, a set of three (in one embodiment) hashes is calculated for every slide in the presentation. The set of three hashes is also referred to as a triple hash. Each hash corresponds to structure, text and format specifiers of its associated slide (document or file). The triple hash enables the document management system of the present invention to identify slides (file components) and use them to construct a new document. The hashes also permit linking of certain file components. The slide is also tagged with metadata that assists the document manager in identifying certain elements of the slide when a user is browsing and searching. The slide tag essentially consists of accountID, account name, libraryID, library name, fileID, file name and the triple-hash. Although the account name, library name and file name may be redundant, these identifiers are attached to the slide to enable other search features that provide information about the slide, without consulting the metadata stored in the repository 14. According to one embodiment, the tag is stored as a comment on the notes page of every slide. This location may be preferred because the comments on the notes page cannot be accessed through any interface with the PowerPoint® application, but can be accessed only programmatically. The tag is also stored in the repository 14. Components of files created using other software programs are similarly tagged for processing, with the tags embedded in or associated with each file component.

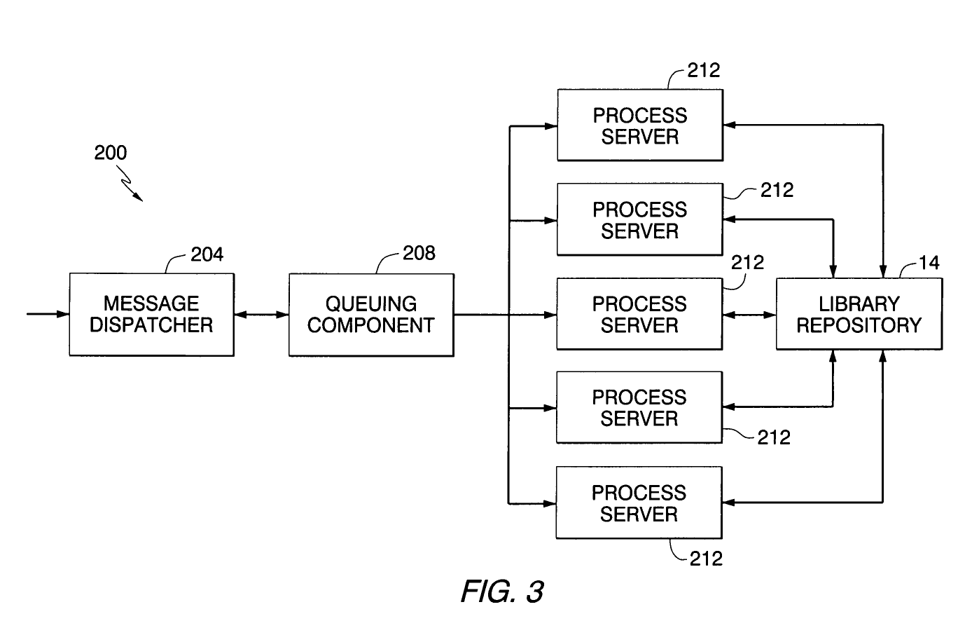

A process server array 200 illustrated in FIG. 3 comprises multiple process servers 212 for processing documents efficiently (i.e., with a high throughput) to implement the features of the document management system 10 described above. Each process server 212 communicates bidirectionally with the file repository 14 to execute document operations as described below.

The process server array 200 operates on multiple documents (retrieved from the depository library 14) simultaneously, decomposing the documents into their components and providing the document management information, as described above, when the documents are imported into the library repository 14. The process server array 200 also operates on the individual document components as required and assembles selected document components into new or derivative documents as described above.

Exemplary tasks performed by the process server array 200 include extraction of text from a document, creation of thumbnail images, sensing and importing linked documents and objects, forming relationships between documents based on pre-established rules or responsive to a user request and assembly of document components into new documents/files.

Referring to FIG. 3, requests for document management enter the process server array 200 through a message dispatcher 204. The message dispatcher 204 processes messages related to other aspects of the document management system 10, forwarding only those messages (requests) related to document management to a queuing component 208 that in turn routes the request to the next available process server 212.

In one embodiment, one or more of the process servers 212 comprises specialized hardware and/or software elements for processing certain requests, e.g., requests related to Adobe® PDF formatted documents. example, certain ones of the process servers 212 may be optimized for executing specific document management tasks. Therefore, such specialized requests are routed to those processors for execution resulting in a faster throughput for execution of the requests. The requests are “intelligently” routed by the queuing component 208 based on the type of request and the role the user plays in optimizing utility of the process server array 200. The number of such processors capable of providing specialized processing is dependent on a specific installation of the processor array 200 and the anticipated user requirements of the installation. In another embodiment, all processors are identically equipped to process all requests generated for the document management system 10. Preferably, each process server 212 self-registers with the queuing component 208 when added to the process server array 200, thus additional process servers 212 can be added as required by the demands of the installation.

After the request has been processed, the process server 212 is available to process subsequent document management requests. Because the process servers 212 operate independently, each document management processing request is independently and more efficiently dispatched, queued and processed according to the teachings of the present invention.

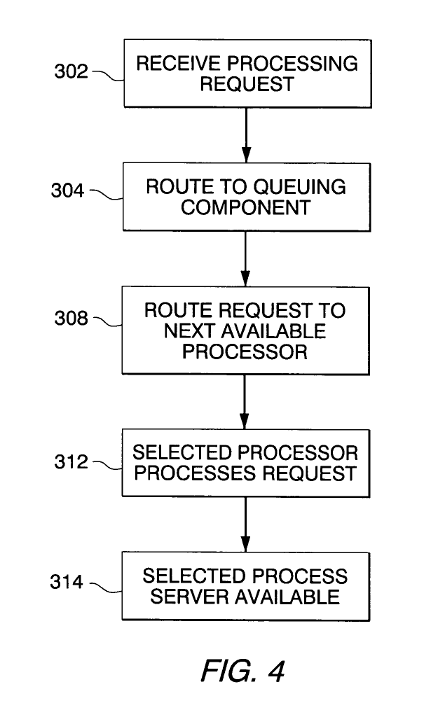

FIG. 4 depicts a flow chart describing operation of the process server array 200 of FIG. 3. At a step 302, a processing request is received and routed to the queuing component 208, as indicated at a step 304. At a step 308, the queuing component 208 routes the request to the next available processor 212. As depicted by a step 312, the selected processor processes the request. Once processing has been completed, the selected process server 212 is again available as indicated at a step 314.

The process server array 200 of the present invention is scalable since additional process servers 212 can be easily added to the process server array 200. Using the array 200 provides real time processing of document management requests, compared with the order and wait model of the prior art. Thus, the process server array 200 provides extremely fast processing and throughput within a document management system, such as the document management system 10 of FIG. 1. The process server array can also manage multiple library repositories 14 due to the resource pooling approach embodied in the process server array 200.

The process server array 200 is a multi-functional resource that can implement any tasks associated with a document management system, including importing and decomposing documents into component parts, building documents from component parts either in response to user requests or according to predetermined system rules, forming relationships between documents and component parts, and editing and dynamically updating contents of the library repository 14 with content from external sources. Notwithstanding the multi-functional capability of the process server array 200 of the present invention, user wait time is reduced because multiple requests are processed simultaneously by the plurality of process servers 212.

While the invention has been described with reference to preferred embodiments, it will be understood by those skilled in the art that various changes may be made and equivalent elements may be substituted for elements thereof without departing from the scope of the invention. The scope of the present invention further includes any combination of the elements from the various embodiments set forth herein. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A process server array for a document management system comprising:
a plurality of processors;
a queuing component for receiving document processing requests for managing a document stored in a document repository of the document management system and assigning each request to an available one of the plurality of processors; and
wherein each request comprises an instruction for processing components of the document by an available one of the plurality of processors.

2. The process server array of claim 1 wherein the instruction comprises decomposing the document into component elements and operating on the elements of the document.

3. The process server array of claim 1 wherein the instruction comprises one or more of decomposing the document into constituent elements, extracting text from the document, creating thumbnail images from the document, determining linked documents, importing linked documents, determining linked document objects, importing linked document objects, relating the document to other documents and assembling the elements to create a new document.

4. The process server array of claim 1 wherein each one of the plurality of processors operates independently of the remaining processors responsive to document processing requests.

5. The process server array of claim 1 wherein following completion of the document processing request the document is stored in the document repository.

6. The process server array of claim 1 wherein the request comprises an instruction to create a new document, and wherein following completion of the request the new document is stored in the document repository.

7. The process server array of claim 1 wherein at any given time one or more of the plurality of processors are operating on different documents from the document repository.

8. The process server array of claim 1 further comprising a message dispatcher responsive to document processing requests initiated by users of the document management system.

9. A method for managing information within a source file, comprising:
importing the source file to a file repository;
initiating a request to decompose the source file into one or more components;
providing the request to a process server array comprising a plurality of process servers;
assigning the request to an available process server from the plurality of process servers;
by operation of the available process server, decomposing the source file into the one or more components; and
storing the one or more components to the file repository.

10. The method of claim 9 further comprising:
receiving a user-initiated request to browse or search the components;
providing the request to an available process server from the plurality of process servers; and
by operation of the available process server, browsing or searching the components in response to the user-initiated request.

11. The method of claim 9 further comprising:
receiving a user-initiated request to create a new document from selected components;
assigning the request to an available process server from the plurality of process servers; and
by operation of the available process server, retrieving the selected components from one or more source files and creating the new document responsive thereto.

12. A method for operating on a document stored in a document repository of a document management system, the method comprising:
receiving a request to operate on the document;
assigning the request to an available process server from a plurality of process servers; and
by operation of the available process server, performing the request.

13. The method of claim 12 wherein the request comprises one or more of decomposing the document into constituent elements, extracting text from the document, creating thumbnail images from the document, sensing linked documents, importing linked documents, sensing linked document objects, importing linked document objects, relating the document to other documents and assembling the elements into a new document.

14. A computer program product for managing information within a file, the computer program comprising:
a computer usable medium having computer readable program code modules embodied in the medium for managing the information;
a computer readable first program code module for importing the source file to a file repository;
a computer readable second program code module for initiating a request to decompose the source file into one or more components;
a computer readable third program code module for providing the request to a process server array comprising a plurality of process servers;
a computer readable fourth program code module assigning the request to an available process server from the plurality of process servers; and
a computer readable fifth program code module operative at the available processor for decomposing the source file into one or more components; and
a computer readable sixth program code module for storing the one or more components to the file repository.
